(19) United States
(12) Patent Application Publication
(10) Pub. No.: US 2006/0197699 A1
(43) Pub. Date: Sep. 7, 2006

(54) Active module integrated into an electronically scanned antenna, and radar comprising such an antenna, applied especially to meteorology

(76) Inventor: Pascal Cornic, (US)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 11/363,545

(22) Filed: Feb. 28, 2006

(30) Foreign Application Priority Data
Mar. 1, 2005 (FR) 05 02062

(51) Int. Cl. G01S 13/95

(52) U.S. Cl. 342/26 R; 342/460; 342/26 B; 342/157; 342/158

(57) ABSTRACT

Active module integrated into an electronically scanned antenna, and radar comprising such an antenna, applied especially to meteorology. The present invention relates to an active module integrated into an electronically scanned antenna. The active module, suitable for radiofrequency transmission, includes at least one power amplifier. This power amplifier delivers a signal that feeds one or more radiating elements. The active module includes at least one waveform generator that delivers a phase-controllable signal to the power amplifier. Another subject of the invention is an electronically scanned antenna comprising radiating elements, each radiating element being fed via at least one active module according to the invention. Yet another subject of the invention is a radar comprising at least one antenna according to the invention. The invention applies to radars and to communication systems employing radiofrequency transmit and receive functions with electronic scanning, such as for example weather radars.

### BACKGROUND OF THE INVENTION

The present invention relates to an active module integrated into an electronically scanned antenna and to a radar comprising such an antenna. In particular, the invention applies to radars and to communication systems employing electronically scanned radiofrequency transmit and receive functions. It also applies for example to weather radars.

Airborne weather radars currently installed on civil aircraft are provided with mechanical scanning systems. This technology, although having a low production cost, does not presently have certain advantages introduced by electronic scanning techniques.

This is because the use of electronic scanning in airborne radars has many advantages, such as, for example great agility in radar mode management or the creation of several functions within the same radar.

However, the implementation of electronic scanning is complex and expensive. This is because, for example in the case of an electronically scanned radar with active modules, each module conventionally comprises the phase-shift and amplification functions for the transmit and receive channels, the control of the transmit and receive channels, the calibration of the amplifiers and the separation of the transmit and receive channels. In addition, all of the active modules must be precisely synchronized. Finally, it is necessary for the transmit power of each of the modules to be finely controlled. The development and production complexity makes it difficult to implement these technologies and the cost of the radar is high.

### SUMMARY OF THE INVENTION

The object of the invention is in particular to alleviate the aforementioned drawbacks. For this purpose, one subject of the invention is an active module suitable for radiofrequency transmission. The active module includes at least one power amplifier, said power amplifier delivering a signal that feeds one or more radiating elements. The active module includes at least one waveform generator that delivers a phase-controllable signal to the power amplifier.

The waveform generator may be a direct digital synthesis circuit.

The waveform generator may deliver an intermediate-frequency signal. The intermediate-frequency signal is frequency transposed and/or multiplied by at least one up-frequency converter.

The active module may include at least one low-noise amplifier and a circulator which is connected, on the one hand, to a radiating element and, on the other hand, to the power amplifier and to the low-noise amplifier. The output signal from the low-noise amplifier is sent to a receiver via an output.

The output signal from the low-noise amplifier may be frequency transposed and/or multiplied by at least one down-frequency converter.

The up-frequency converter may send to the down-frequency converter a delayed signal which is the conjugate of the signal sent to the power amplifier, the down-frequency converter multiplying the signal received from the low-noise amplifier by the conjugate signal.

Another subject of the invention is an electronically scanned antenna comprising radiating elements, each radiating element being fed via at least one active module according to the invention.

The electronically scanned antenna may include at least one pointing phase control circuit that delivers a phase setpoint specific to each active module, the phase being determined for each active module according to the desired pointing direction.

Yet another subject of the invention is a radar comprising at least one antenna according to the invention.

The radar may include at least one pointing phase control circuit that delivers a phase setpoint specific to each active module, the phase being determined for each active module according to the desired pointing direction.

The radar may especially be applied to the detection and location of meteorological phenomena.

In particular, the invention has the advantages of making it possible to simplify the design of the active modules of the electronically scanned radar by eliminating the functions that are difficult to produce in microwave technology.

In addition, the invention makes it possible to increase the reliability of the radar by parallelizing the transmit function. It also makes it possible to simplify, or even eliminate, the calibration of the active modules.

### BRIEF DESCRIPTION OF THE DRAWINGS

Other features and advantages of the invention will become apparent from the description that follows, given with regard to the appended drawings which show, schematically:
FIG. 1, an electronically scanned antenna with active modules according to the prior art;
FIG. 2, an electronically scanned antenna with active modules according to the invention, by distributed waveform generation; and
FIG. 3, another embodiment of an active module according to the invention.

### MORE DETAILED DESCRIPTION

FIG. 1 illustrates an electronically scanned antenna with active modules according to the prior art. It comprises in particular a waveform generator 1 and a set of active modules 2 that are distributed over the surface of an antenna, each connected to one or more radiating elements 3. Each active module 2 comprises at least one transmit channel, said transmit channel having at least one microwave phase shifter 7 and a power amplifier 4. Each active module 2 may further include a receive channel, said receive channel having a microwave phase shifter 7 and a low-noise amplifier 5.

A circulator 6 is inserted between, on the one hand, the transmit and receive channels and, on the other hand, between one or more radiating elements 3, in such a way that a signal output by the transmit channel passes to the radiating element 3 and a signal output by the radiating element 3 passes into the receive channel.

All the active modules 2 receive, on the transmit channel, a signal to be transmitted that comes from the waveform generator 1. The receive channel terminates in a receiver via an output 8.

The electronic scanning function is performed by the microwave phase shifters 7 present in each active module 2. The signal received from the waveform generator 1 is phase-shifted by a certain amount for each active module 2, the applied phase shift being especially dependent on the desired direction for the antenna beam.

In particular, each active module 2 provides the following functions:
phase shift and amplification with amplitude control of the signal at transmission;
low-noise amplification, phase shift and amplitude control of the signal at reception;
control and calibration; and
separation of the transmit and receive channels.

The number of functions carried out within each active module 2 introduces considerable complexity because of the very high level of integration of the microwave functions. It also proves tricky to distribute the microwave signals. To give an example, in order to obtain a satisfactory radiation pattern and thus maintain given requirements relating to the performance of the radar, it is necessary to guarantee relative stability in terms of phase amplitude of the various active modules 2. Each active module 2 must therefore be provided with a microwave level calibration device and each microwave phase shifter 7 must have a high number of bits. As a result, the cost per active module 2 is high.

FIG. 2 shows an electronically scanned antenna according to the invention. This antenna with a modular structure especially comprises a series of active modules 20. Each active module 20 has in particular a transmit channel comprising:
a waveform generator 21 delivers a signal e₁, e₂, . . . , eₙ;
an up-frequency converter 22 that delivers a signal e₁′, e₂′, . . . , e′ₙ; and
a power amplifier 4.

Each active module may include a receive channel. This receive channel comprises especially:
a low-noise amplifier 5 that delivers a signal s₁′, s₂′, . . . , sₙ′; and
a down-frequency converter 23.
   The output signal from the down-frequency converter 23 is sent to an output 8 connected to one or more receivers.

A circulator 6 is inserted between the transmit channel and the receive channel of each active module 20.

The antenna includes in particular a set of active modules 20. The circulators 6 for these active modules 20 are connected to one or more radiating elements.

The antenna also includes at least one pointing phase control circuit 24 that in particular delivers phase setpoints to the waveform generator 21 of each active module 20.

Time signals C_{ref} delivered by at least one reference clock 25 are distributed to the waveform generators of the active modules 20. At least one local oscillator 26 delivers time signals LO to the up-frequency converters 22 and to the down-frequency converters 23.

The active modules 20 correspond to functional entities. In addition, the components of an active module 20 may be physically located on several supports or, on the contrary, may be grouped together in one and the same component. Likewise, the pointing phase control circuit 24, the reference clock 25 and the local oscillator 26 may be physically separate from the antenna.

The waveform generators 21 receive phase setpoints from the pointing phase control circuit 24. The waveform generators 21 also receive a frequency setpoint in the form of a reference time signal C_{ref} delivered by the reference clock 25. Each waveform generator 21 synthesizes, from these signals, a waveform e₁, e₂, . . . , eₙ at an intermediate frequency corresponding to the setpoint, for example 1 GHz. The signal e₁, e₂, . . . , eₙ delivered by each waveform generator 21 is therefore a phase-controllable signal, since the phase of this signal e₁, e₂, . . . , eₙ generated is slaved to the setpoint received by the waveform generator 21.

The up-frequency converters 22 receive as input the intermediate-frequency signals e₁, e₂, . . . , eₙ that are delivered by the waveform generators 21 and the time signal LO output by the local oscillator 26. The up-frequency converters 22 multiply the signals e₁, e₂, . . . , eₙ by the time signal LO and then, if necessary, apply, to the resulting signal, a multiplication by a preset factor, thus obtaining output signals e₁′, e₂′, . . . , eₙ′. The up-frequency converters 22 carry out a frequency transposition and multiplication function. The signals e₁′, e₂′, . . . , eₙ ′ are then amplified by power amplifiers 4 before being transmitted.

The down-frequency converters 23 receive as input the signals s₁′, s₂′, . . . , sₙ ′ received from the low-noise amplifiers 5, and also the time signal LO output by the local oscillator 26. The down-frequency converters 23 multiply the signals s₁′, s₂′, . . . , Sₙ ′ by the time signal LO and then apply, if necessary, to the resulting signal a multiplication by a preset factor, thus obtaining intermediate-frequency output signals s₁, s₂, . . . , Sₙ. The down-frequency converters 24 therefore carry out a frequency transposition function. The signals s₁, s₂, . . . , sₙ are then sent back via the outputs 8 to one or more receivers so as to be processed and presented to the user.

An electronically scanned antenna with distributed waveform generation is thus obtained. This is because the waveform generation is decentralized in each active module 20 of the antenna. The transmit function is completely parallelized and partially redundant: the single point of failure formed by the single waveform generator 1 of an antenna according to the prior art is eliminated by decentralizing the waveform generators 21 in each active module 20 in an antenna according to the invention.

Advantageously, an antenna according to the invention no longer uses a phase shifter 7. The active modules 20 no longer perform phase-shifting operations on the signal to be transmitted since the waveform generators 21 fulfil this function. The functions conventionally carried out at microwave frequency in active modules 20 are transferred to the waveform generators 21 at intermediate frequency. Each active module 20 is associated with a waveform generator 21. The transmit function is also completely parallelized and consequently more robust and more reliable with respect to possible failures. The various control circuits (not shown in the figures) may thus be used for operation at intermediate frequency.

In one embodiment, the waveform generators 21 are implemented in the form of digital synthesis circuits. The waveform generators 21 receive a frequency setpoint in the form of time signals delivered by one or more reference clocks 25. The waveforms output by these circuits may be frequency transposed and/or multiplied in order to generate the microwave intended to feed the power amplifiers 4.

The waveform generators 21 may be phase-controlled and frequency-controlled with great stability over time and with high spectral purity. The calibration of the active modules is therefore simplified, or even eliminated. It is also possible, using a single clock, to generate a different waveform for each transmit channel, but one which is however consistent with the other waveforms.

In another embodiment, the radar uses the technique of pulse compression. The waveform generators 21 then deliver, consistently and independently, a compression code to each of the transmit channels, said compression code being phase-shifted for each channel according to the desired pointing direction. The waveform generators 21 may therefore perform the pulse compression and the phase shift of the wave plane at transmission.

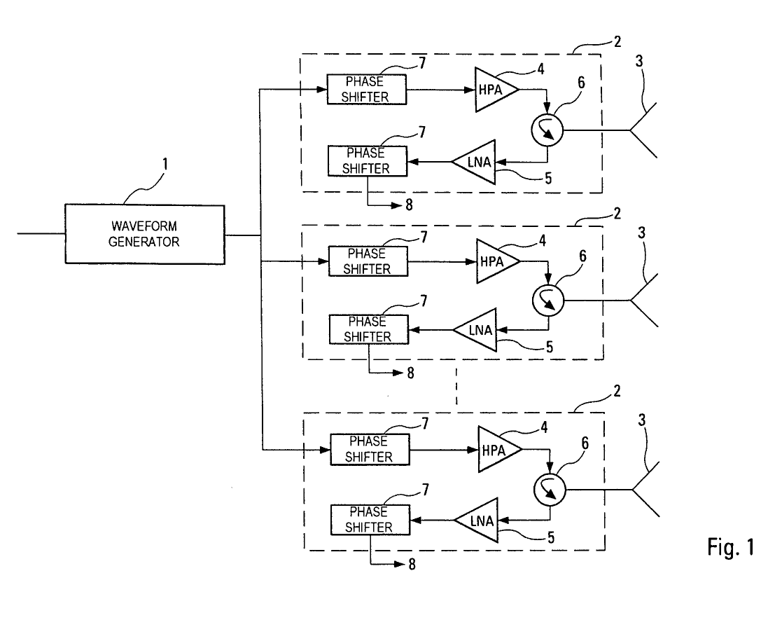

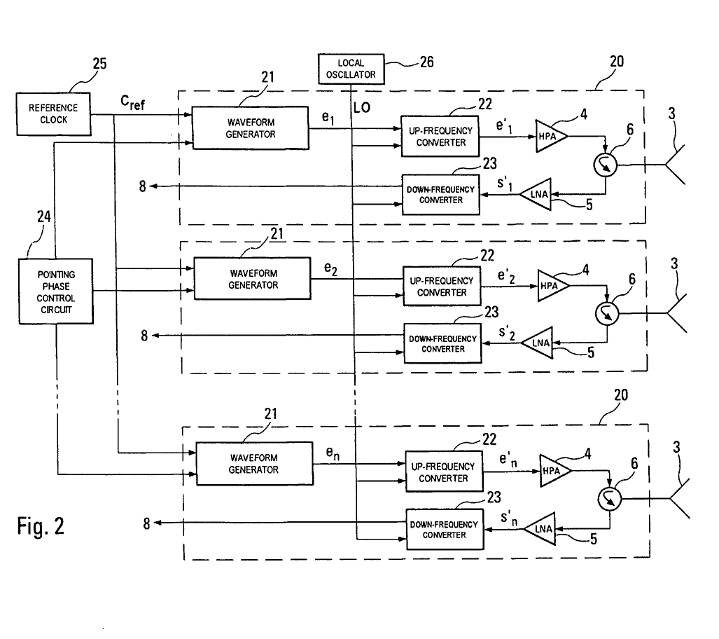

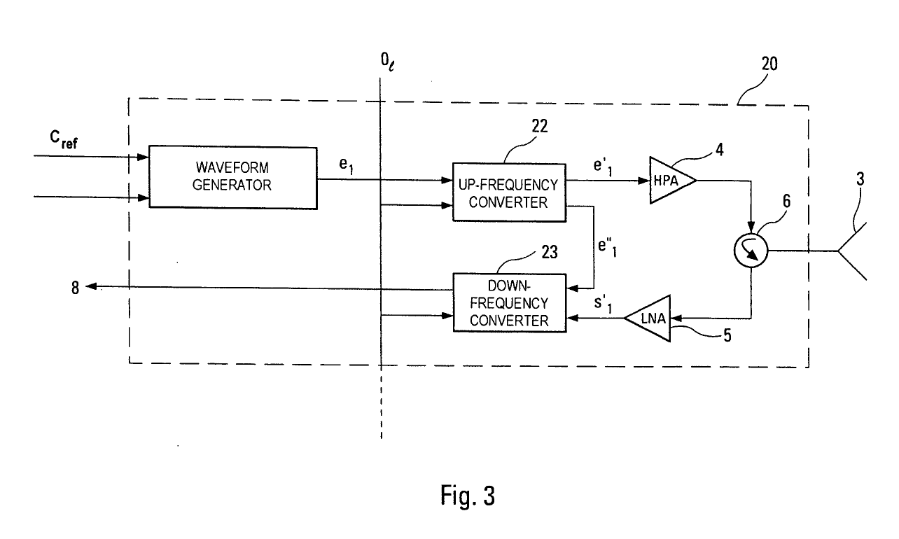

FIG. 3 illustrates another embodiment of an active module according to the invention. The numbering in this figure repeats that of FIG. 2. The up-frequency converter 22 transmits a signal e₁″ to the down-frequency converter 23. The signal e₁″ is the delayed conjugate signal of the signal e₁′. The signal s₁′ received on the receive channel is multiplied in the down-frequency converter 23 by the delayed conjugate signal e₁″ of the transmitted waveform. The beam is therefore formed by the waveform generator 21.

The invention may especially be used in a weather radar or in an anti-collision radar. This radar may be an airborne radar.

1. An active module suitable for radiofrequency transmission, comprising at least one power amplifier, said power amplifier delivering a signal that feeds one or more radiating element, including at least one waveform generator delivering a phase-controllable signal (e₁,e₂, . . . , eₙ) to the power amplifier.

2. The active module according to claim 1, wherein the waveform generator is a direct digital synthesis circuit.

3. The active module according to claim 1, wherein the waveform generator delivers an intermediate-frequency signal (e₁,e₂, . . . , eₙ).

4. The active module according to claim 3 wherein the signal (e₁,e₂, . . . , eₙ) delivered by the waveform generator is frequency transposed and/or multiplied by at least one up-frequency converter.

5. The active module according to claim 1, wherein it includes at least one low-power amplifier and a circulator which is connected, on the one hand, to a radiating element and, on the other hand, to the power amplifier and to the low-noise amplifier, the output signal s₁′, s₂′. . . , sₙ′) of the low-noise amplifier being sent to a receiver via an output 8.

6. The active module according to claim 5, wherein the signal (s₁′, s₂′, . . . , sₙ′) is frequency transposed and/or multiplied by at least one down-frequency converter.

7. The active module according to claim 4, wherein the signal (s₁′, s₂′, . . . , sₙ′) is frequency transposed and/or multiplied by at least one down-frequency converter 3, the up-frequency converter sending to the down-frequency converter a retarded signal (e″1) which is the conjugate of the signal (e′1) sent to the power amplifier, the down-frequency converter multiplying the signal (s₁′, s₂′, . . . sₙ′) received from the low-noise amplifier by the conjugate signal (e″1).

8. An electronically scanned antenna comprising radiating elements, each radiating element being fed via at least one active module according to claim 1.

9. An electronically scanned antenna according to claim 8 wherein it includes at least one pointing phase control circuit that delivers a phase setpoint specific to each active module, the phase being determined for each active module according to the desired pointing direction.

10. A radar comprising at least one antenna according to claim 8.

11. A radar according to claim 10, wherein it includes at least one pointing phase control circuit that delivers a phase setpoint specific to each active module, the phase being determined for each active module according to the desired pointing direction.

12. A radar comprising at least one antenna according to claim 9.

13. A radar according to claim 1 wherein it is applied to the detection and location of meteorological phenomena.
